(19) United States
(12) Patent Application Publication
(10) Pub. No.: US 2010/0143586 A1
(43) Pub. Date: Jun. 10, 2010

(54) Spin coating apparatus, spin coating method, and method for manufacturing information recording medium

(75) Inventors: Toshiaki Ide, Tokyo (JP); Takeshi Umega, Tokyo (JP); Motohiro Sakurai, Tokyo (JP); Minoru Fujita, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/591,742

(22) Filed: Nov. 30, 2009

(30) Foreign Application Priority Data
Dec. 10, 2008 (JP) 2008-314921

(51) Int. Cl. B05D 3/12; B05C 11/02

(52) U.S. Cl. 427/240; 118/52

(57) ABSTRACT

The spin coating apparatus includes: a collet including a tubular portion disposed coaxially with a predetermined rotation axis, the tubular portion having a slit that extends from a top portion of the tubular portion in a direction of the rotation axis to a midway part in the direction of the rotation axis; and a diameter-expanding member for urging the tubular portion of the collet radially outwardly to expand the outer diameter of the tubular portion. With the spin coating apparatus, a plate-like workpiece having a center hole is held at the center hole by the tubular portion of the collet with both sides of the workpiece exposed, and a flowable material can be applied to both the sides of the workpiece.

### BACKGROUND OF THE INVENTION

1. Field of the Invention

The present invention relates to a spin coating apparatus used to apply a flowable material to the surface of a workpiece, to a spin coating method using the same, and to a method for manufacturing an information recording medium.

2. Description of the Related Art

Spin coating apparatus are conventionally used in various fields. For example, in a manufacturing process of optical recording media such as CDs (Compact Discs), a spin coating apparatus is used to deposit an organic dye used as the material for a recording film. Such a spin coating apparatus includes: a table for holding a workpiece; and a driving unit for rotating the table and the workpiece. A flowable material is supplied near the rotational center of the upper surface (the surface opposite to the surface in contact with the table) of the workpiece. The workpiece is rotated together with the table, so that the centrifugal force causes the flowable material to flow radially outwardly. Accordingly, the flowable material is spread over the entire surface of the workpiece (see, for example, Japanese Patent Application Laid-Open No. 2008-52790).

Also in a manufacturing process of magnetic recording media such as hard disks, it is expected to use a spin coating apparatus to apply a flowable material to the surface of a workpiece. For example, in the field of magnetic recording media, discrete track media and patterned media have been proposed to increase the recording density. It should be noted that the discrete track media have a recording layer that is formed in a concavo-convex pattern corresponding to tracks, and the patterned media have a recording layer that is formed in a concavo-convex pattern corresponding to recording bits. An unprocessed recording layer can be processed into the concavo-convex pattern corresponding to the tracks or recording bits as follows. First, a resin layer is deposited on the unprocessed recording layer, and the deposited resin layer is processed into a concavo-convex pattern corresponding to the concavo-convex pattern of the final recording layer by imprinting or lithography. Then the unprocessed recording is etched in accordance with the resin layer processed in the concavo-convex pattern. In another proposed method, one or two or more mask layers are deposited between the recording layer and the resin layer. Then the mask layers are etched in accordance with the patterned resin layer, and the recording layer is etched in accordance with the patterned mask layers. Japanese Patent Application Laid-Open Nos. 2008-217908 and 2008-171499, for example, propose to use a spin coating apparatus to deposit the resin layer on the recording layer or the mask layer.

Meanwhile, many magnetic recording media such as hard disks are of the double-side recording type in which recording layers are provided on both sides of the substrate. A conventional spin coating apparatus is designed to apply a flowable material to only one side (upper side) of a workpiece. Therefore, when a magnetic recording medium of the double-side recording type is manufactured, a flowable material is first applied to one side of a workpiece. Then the workpiece having the flowable material applied to the one side thereof must be turned upside down to apply the flowable material to the other side. The problem of manufacturing the magnetic recording medium of the double-side recording type using the conventional spin coating apparatus is that the production efficiency is low. Moreover, when the workpiece having the flowable material applied to the one side is turned upside down, the applied flowable material can flow. This causes difficulty in maintaining a uniform applied layer thickness. In addition, when turned upside down, the workpiece must be handled such that the flowable material applied to the one side does not come into contact with a jig and other parts. Therefore, disadvantageously, the handling of the workpiece is troublesome.

### SUMMARY OF THE INVENTION

In view of the foregoing problems, various exemplary embodiments of this invention provide a spin coating apparatus that can apply a flowable material to both sides of a workpiece with high production efficiency. Furthermore, various exemplary embodiments of the invention provide a spin coating method using the same and a method for manufacturing an information recording medium.

Various exemplary embodiments of the present invention achieve the above object by providing a spin coating apparatus, including: a collet including a tubular portion disposed coaxially with a predetermined rotation axis, the tubular portion having a slit that extends from a top portion of the tubular portion in a direction of the rotation axis to a midway part in the direction of the rotation axis; and a diameter-expanding member for urging the tubular portion of the collet radially outwardly to expand an outer diameter of the tubular portion. In this configuration, while a plate-like workpiece having a center hole is held at the center hole by the tubular portion of the collet with both sides of the workpiece exposed, the apparatus can apply a flowable material to both the sides of the workpiece.

This spin coating apparatus can apply the flowable material to both sides of the workpiece while the workpiece is held at the center hole thereof by the tubular portion of the collet with both sides of the workpiece exposed. Therefore, high production efficiency is attained.

In the course of arriving at the present invention, the inventors have noticed that, when a collet having slits is used, unevenness in thickness, like wind ripple patterns, is sometimes formed in the flowable material applied to a workpiece. More specifically, the wind ripple patterns have substantially arc-like shapes extending radially outwardly from the slits of the collet. It is presumed that the wind ripple patterns are formed because centrifugal force causes air to flow from the slits of the collet. The wind ripple patterns are more likely to be formed particularly on the rear surface of the workpiece (the surface opposite to the surface of the workpiece facing in the same direction as the end face of the top portion of the tubular portion of the collet facing the direction of the rotation axis) and are less likely to be formed on the front surface of the workpiece (the surface facing in the same direction as the end face of the top portion of the tubular portion of the collet facing the direction of the rotation axis).

For example, when such wind ripple patterns are formed only near the center hole of the workpiece and are not formed in an area corresponding to the recording area of a magnetic recording medium, the wind ripple patterns do not cause serious problems. However, it is preferable to suppress the formation of such wind ripple patterns as much as possible. The present inventors have conducted extensive studies and found that the formation of the wind ripple patterns can be suppressed by covering the hole inside the tubular portion at the top portion of the collet and also covering at least parts of the slits at the end face of the top portion facing the rotation axis direction.

Accordingly, various exemplary embodiments of this invention provide a spin coating apparatus, comprising: a collet including a tubular portion disposed coaxially with a predetermined rotation axis, the tubular portion having a slit that extends from one top portion of the tubular portion in a direction of the rotation axis to a midway part in the direction of the rotation axis; and a diameter-expanding member for urging the tubular portion of the collet radially outwardly to expand an outer diameter of the tubular portion, wherein while a plate-like workpiece having a center hole is held at the center hole by the tubular portion of the collet with both sides of the workpiece exposed, the spin coating apparatus can apply a flowable material to both the sides of the workpiece.

Moreover, various exemplary embodiments of this invention provide a spin coating method, comprising applying the flowable material to both the sides of the workpiece using the spin coating apparatus.

Furthermore, various exemplary embodiments of this invention provide a method for manufacturing an information recording medium, comprising a step of applying the flowable material to both the sides of the workpiece using the spin coating apparatus.

According to various exemplary embodiments of the present invention, a spin coating apparatus that can apply a flowable material to both sides of a workpiece and has high production efficiency, a spin coating method using the same, and a method for manufacturing an information recording medium can be achieved.

### BRIEF DESCRIPTION OF THE DRAWINGS

FIG. 1 is a partially cross-sectional side view schematically illustrating the structure of the main part of a spin coating apparatus according to an exemplary embodiment of the present invention;

FIG. 2 is a partially cross-sectional enlarged side view illustrating a collet shown in FIG. 1 and its surroundings;

FIG. 3 is an enlarged side view as viewed along arrow III in FIG. 1;

FIG. 4 is a plan view including a cross-section taken along line IV-IV in FIG. 1;

FIG. 5 is a flowchart showing the outline of a method for manufacturing an information recording medium using the spin coating apparatus;

FIG. 6 is a cross-sectional side view schematically illustrating a concavo-convex pattern transferring step in the method for manufacturing the information recording medium;

FIG. 7 is a cross-sectional side view schematically illustrating an etching step in the method for manufacturing the information recording medium;

FIG. 8 is a photograph showing the rear surface of the workpiece in Working Example 1; and

FIG. 9 is a photograph showing the rear surface of the workpiece in Working Example 2.

### DETAILED DESCRIPTION OF THE PREFERRED EMBODIMENTS

Hereinafter, preferred exemplary embodiments of the present invention will be described in detail with reference to the drawings.

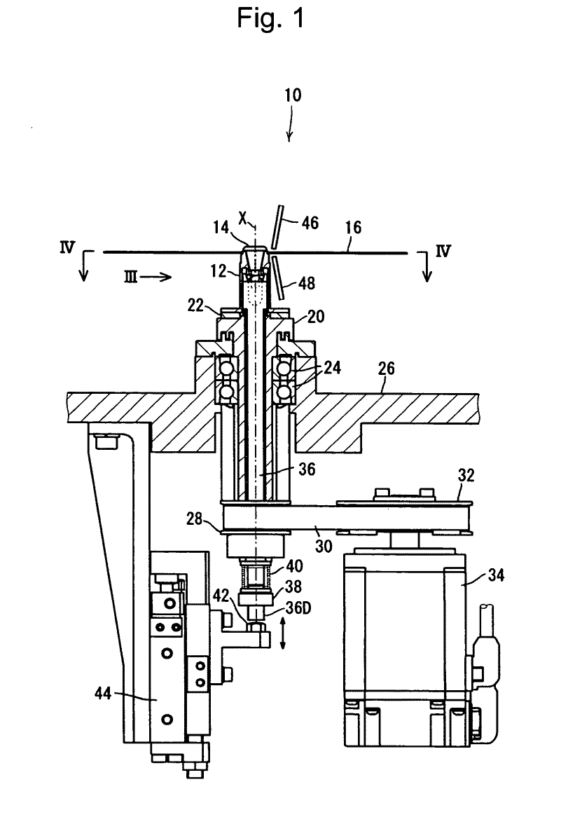

FIG. 1 is a partially cross-sectional side view schematically illustrating the structure of the main part of a spin coating apparatus according to an exemplary embodiment.

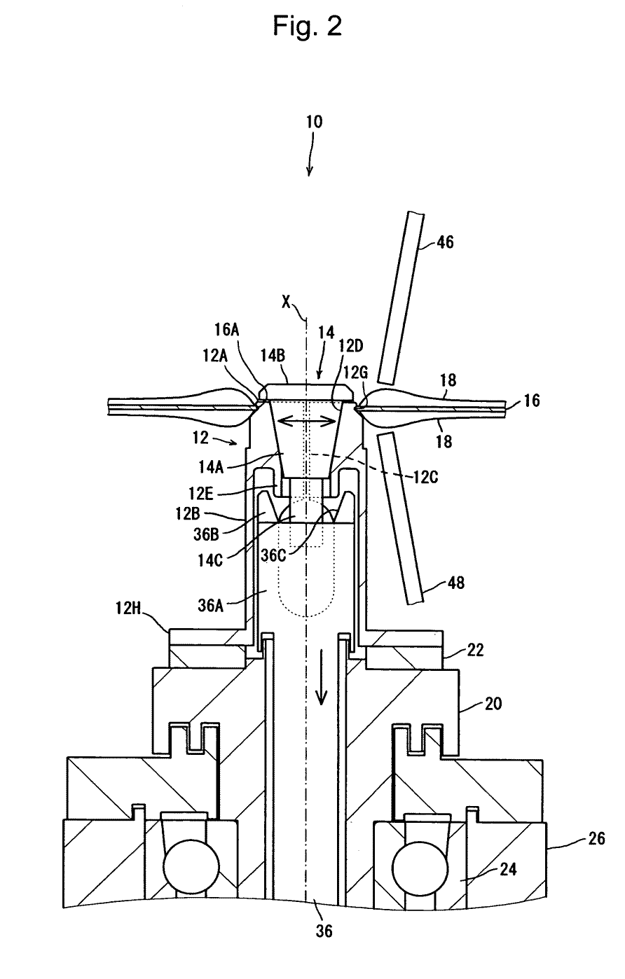

FIG. 2 is a partially cross-sectional enlarged side view illustrating the collet shown in FIG. 1 and its surroundings.

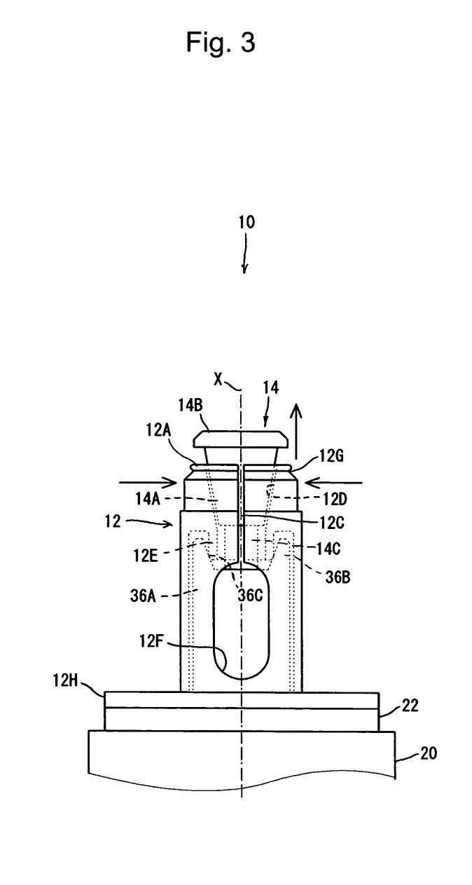

FIG. 3 is an enlarged side view as viewed along arrow III in FIG. 1. In FIG. 3, a workpiece and nozzle portions are omitted for convenience.

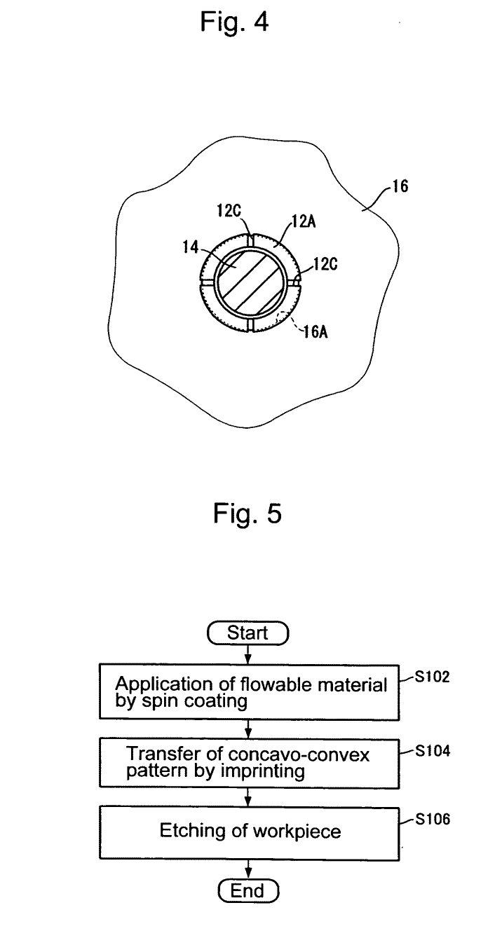

FIG. 4 is a plan view including a cross-section taken along line IV-IV in FIG. 1.

As shown in FIGS. 1 to 4, the spin coating apparatus 10 according to the present exemplary embodiment includes: a collet 12 including a tubular portion 12B disposed coaxially with a rotation axis X, the tubular portion 12B having slits 12C that extend from a top portion 12A of the tubular portion 12B in a direction of the rotation axis X to a midway part in the direction of the rotation axis X; and a diameter-expanding member 14 for urging the tubular portion 12B of the collet 12 radially outwardly to expand the outer diameter of the tubular portion 12B. While a plate-like workpiece 16 having a center hole 16A is held at the center hole 16A by the tubular portion 12B of the collet 12 with both sides of the workpiece 16 exposed, the spin coating apparatus 10 can apply a flowable material 18 to both the sides of the workpiece 16 simultaneously.

The collet 12 has a tapered surface 12D which is an inner circumferential surface of the top portion 12A and therearound of the tubular portion 12B. The tapered surface 12D has a diameter that decreases as the distance from the top portion 12A increases. An annular projection 12E is formed inside the tubular portion 12B so as to project from the end of the tapered surface 12D opposite to the top portion 12A in the direction away from the top portion 12A. The slits 12C are formed in a plurality of positions (4 positions in the present exemplary embodiment) in the tubular portion 12B at appropriate circumferential intervals. The slits 12C are formed also in the annular projection 12E, and thus the annular projection 12E has a discontinuous annular shape divided by the slits 12C. Elongated holes 12F elongated in the direction of the rotation axis X are formed in the tubular portion 12B so as to be continuous with the end of the slits 12C that is on the side opposite to the top portion 12A. Thus, the elongated holes 12F and the slits 12C form continuous notches. The collet 12 further has a neck portion 12G formed at the top portion 12A of the tubular portion 12B. The neck portion 12G has an outer diameter smaller than the outer diameter of adjoining portions on both sides thereof in the direction of the rotation axis X. The collet 12 is configured so as to be capable of holding the workpiece 16 with the center hole 16A of the workpiece 16 fitted onto the neck portion 12G. Moreover, a flange portion 12H is provided at the other end portion of the tubular portion 12B in the direction of the rotation axis X, the other end portion being opposite to the top portion 12A.

The collet 12 is attached at the flange portion 12H to one end of a tubular rotor 20 through a spacer 22, the rotor being disposed coaxially with the rotation axis X. The rotor 20 is rotatably supported by a base member 26 through bearings 24, and the movement of the rotor 20 in the direction of the rotation axis X is restricted by the bearings 24. A pulley 28 is attached near the other end of the rotor 20, and the rotation of a motor 34 is transmitted to the pulley 28 through a belt 30 and a pulley 32.

The diameter-expanding member 14 includes: a truncated cone-shaped main portion 14A that can be fitted into the tapered surface 12D of the collet 12; a flange portion 14B provided at a large-diameter end of the main portion 14A; and a connection portion 14C that coaxially protrudes from a small-diameter end of the main portion 14A. The diameter-expanding member 14 is configured such that the main portion 14A is urged in the direction of the rotation axis X so as to come in contact with the tapered surface 12D of the collet 12 from the top portion 12A side, whereby the tubular portion 12B of the collet 12 is urged radially outwardly to expand the outer diameter of the tubular portion 12B.

The diameter-expanding member 14 is also configured such that the main portion 14A can cover the hole inside the tubular portion 12B of the collet 12 at the top portion 12A of the collet 12 and that the flange portion 14B can cover at least parts of the slits 12C of the collet 12 at the end face of the top portion 12A facing the direction of the rotation axis X. More specifically, the diameter-expanding member 14 serves also as a covering member that can cover the hole inside the tubular portion 12B at the top portion 12A of the collet 12 and can also cover at least parts of the slits 12C at the end face of the top portion 12A facing the direction of the rotation axis X.

The diameter-expanding member 14 is connected at the connection portion 14C to a head portion 36A of a connection bar 36 disposed inside the collet 12 and the rotor 20. The head portion 36A of the connection bar 36 has protrusions 36B formed to protrude toward the top portion 12A of the collet 12. The radially inner surface (the surface close to the rotation axis X) of the protrusion 36B is formed as a tapered surface 36C that is formed such that the radial distance from the rotation axis X increases in the direction toward the top portion 12A of the collet 12. When the protrusion 36B is urged toward the top portion 12A and the tapered surface 36C thereof comes in contact with the annular projection 12E inside the collet 12, the tubular portion 12B of the collet 12 is urged radially inwardly. Specifically, the connection bar 36 is configured to serve as a diameter-reducing member that can urge the tubular portion 12B of the collet 12 radially inwardly.

A tail portion 36D of the connection bar 36, that is on the side opposite to the head portion 36A, protrudes from the rotor 20, and a spring seat member 38 is attached near the tail portion 36D. A compression coil spring 40 is mounted between the spring seat member 38 and the end of the rotor 20 so as to surround the connection bar 36, so that, in an ordinary state, the connection bar 36 is urged in the direction away from the top portion 12A of the collet 12. In this configuration, in the ordinary state, the main portion 14A of the diameter-expanding member 14 is urged in the direction of the rotation axis X (the direction toward the spring seat member 38) and comes in contact with the tapered surface 12D of the collet 12, and the tubular portion 12B of the collet 12 is thereby urged radially outwardly.

A pushing member 42 is provided on the side of the tail portion 36D of the connection bar 36, the side being away from the top portion 12A of the collet 12, so as to face the tail portion 36D of the connection bar 36. The pushing member 42 is driven by an actuator 44 so as to freely move in the direction of the rotation axis X. In this configuration, when the pushing member 42 driven by the actuator 44 comes in contact with the tail portion 36D of the connection bar 36, the connection bar 36 is urged toward the top portion 12A of the collet 12 against the urging force of the compression coil spring 40. The large-diameter portion of the main portion 14A of the diameter-expanding member 14 is thereby moved in the direction away from the tapered surface 12D of the collet 12, so that the elastic force of the collet 12 causes the outer diameter of the tubular portion 12B of the collet 12 to be reduced. Also in this configuration, when the tapered surface 36C of the protrusion 36B of the head portion 36A of the connection bar 36 comes in contact with the annular projection 12E inside the collet 12, the protrusion 36B of the head portion 36A urges the tubular portion 12B of the collet 12 radially inwardly. This facilitates the reduction in the outer diameter of the tubular portion 12B of the collet 12. Moreover, since the protrusion 36B of the head portion 36A of the connection bar 36 urges the tubular portion 12B of the collet radially inwardly, the outer diameter of the tubular portion 12B of the collet 12 can be smaller than that in the ordinary state (the state in which the tubular portion 12B is not urged radially by the diameter-expanding member 14 and the connection bar 36 (the diameter-reducing member)).

The spin coating apparatus 10 further includes a pair of nozzle portions 46 and 48 for applying a flowable material to both sides of the workpiece 16. The nozzle portions 46 and 48 are configured to eject the flowable material 18 toward the vicinity of the center hole 16A of the workpiece 16.

The workpiece 16 has, for example, a substrate for a magnetic recording medium such as a hard disk and layers such as magnetic recording layers deposited on both sides of the substrate. The outer diameter of the workpiece 16 is, for example, 30 to 90 mm. The diameter of the center hole 16A is, for example, 12 to 25 mm. The thickness of the workpiece 16 is, for example, 0.5 to 1.2 mm.

The flowable material 18 is, for example, a radiation curable resin such as a UV curable resin, a thermosetting resin, or a resist material.

The spin coating apparatus 10 is contained in a casing (not shown). If necessary, a drain hole for discharging an excess flowable material 18 flying out of the outer circumference of the workpiece 16 is provided on the bottom of the casing. A negative pressure pump, for example, is connected to the drain hole, and the excess flowable material 18, together with air in the casing, is sucked and discharged to the outside of the casing.

Next, with reference to a flowchart shown in FIG. 5, a spin coating method using the spin coating apparatus 10 will be described. Specifically, a description will be given of a method for manufacturing an information recording medium using the spin coating apparatus 10, as an example. In an initial state, the motor 34 is at rest, and the pushing member 42 is spaced apart from the tail portion 36D of the connection bar 36.

First, the flowable material 18 is applied to the entire area on both sides of the workpiece 16 (S102). Specifically, the actuator 44 moves the pushing member 42 toward the tail portion 36D of the connection bar 36 to urge the connection bar 36 toward the top portion 12A of the collet 12 against the urging force of the compression coil spring 40. The large-diameter portion of the main portion 14A of the diameter-expanding member 14 is thereby moved in the direction away from the tapered surface 12D of the collet 12, and the elastic force of the collet 12 causes the outer diameter of the tubular portion 12B of the collet 12 to be reduced. Further, the tapered surface 36C of the protrusion 36B of the head portion 36A of the connection bar 36 comes in contact with the annular projection 12E inside the collet 12 and urges the tubular portion 12B of the collet 12 radially inwardly. This facilitates the reduction in the outer diameter of the tubular portion 12B. Since the protrusion 36B of the head portion 36A of the connection bar 36 urges the tubular portion 12B of the collet 12 radially inwardly, the outer diameter of the tubular portion 12B of the collet 12 can be smaller than that in the ordinary state (the state in which the tubular portion 12B is not urged radially by the diameter-expanding member 14 and the connection bar 36 (the diameter-reducing member)). Then the workpiece 16 is placed so as to be coaxial with the rotation axis X and such that the center hole 16A of the workpiece 16 substantially coincides with the neck portion 12G of the top portion 12A of the collet 12.

Subsequently, the pushing member 42 is driven by the actuator 44 so as to be moved in the direction away from the tail portion 36D of the connection bar 36. The connection bar 36 is urged by the compression coil spring 40 and moved in the direction away from the top portion 12A of the collet 12. The tapered surface 36C of the protrusion 36B of the head portion 36A of the connection bar 36 is thereby separated from the annular projection 12E inside the collet 12. Moreover, the main portion 14A of the diameter-expanding member 14 is urged in the direction of the rotation axis X and comes in contact with the tapered surface 12D of the collet 12 from the top portion 12A side, and therefore the tubular portion 12B of the collet 12 is urged radially outwardly. The outer diameter of the tubular portion 12B is thereby expanded, and the neck portion 12G of the top portion 12A of the collet 12 is fitted into the inner circumference of the center hole 16A of the workpiece 16. The workpiece 16 is held at the center hole 16A by the tubular portion 12B of the collet 12 such that both sides of the workpiece 16 are exposed.

In this state, the motor 34 is actuated to rotate the workpiece 16 at a rotation speed of, for example, about several thousands to several tens of thousands of rpm (in one example, 10,000 rpm). Then as shown in FIG. 2, a predetermined amount of the flowable material 18 is ejected from the nozzle portions 46 and 48 toward the vicinities of the center hole 16A on both sides of the workpiece 16. The flowable material 18 is thereby urged by the centrifugal force to flow radially outwardly, and is spread over the entire area on both sides of the workpiece 16. The flowable material 18 ejected onto the rear surface of the workpiece 16 (the surface opposite to the surface of the workpiece 16 facing in the same direction as the end face of the top portion 12A of the tubular portion 12B of the collet 12 facing the direction of the rotation axis X) is urged by gravity in the direction away from the rear surface of the workpiece 16. However, the flowable material 18 ejected onto the rear surface of the workpiece 16 remains adhering to the rear surface due to its viscosity and is caused to flow radially outwardly by the centrifugal force of the workpiece 16 rotated at a high speed. Therefore, the flowable material 18 is applied to the rear surface of the workpiece 16, as well as to the front surface. After a predetermined time, the flowable material 18 is applied to the entire area on both sides of the workpiece 168 to a desired thickness, and the motor 34 is then stopped.

Subsequently, the actuator 44 is driven to move the pushing member 42 toward the tail portion 36D of the connection bar 36, and the connection bar 36 is urged toward the top portion 12A of the collet 12 against the urging force of the compression coil spring 40. The large-diameter portion of the main portion 14A of the diameter-expanding member 14 is thereby moved in the direction away from the tapered surface 12D of the collet 12, and the elastic force of the collet 12 causes the outer diameter of the tubular portion 12B of the collet 12 to be reduced. Moreover, the tapered surface 36C of the protrusion 36B of the head portion 36A of the connection bar 36 comes in contact with the annular projection 12E inside the collet 12 from the side opposite to the top portion 12A, and the tubular portion 12B of the collet 12 is thereby urged radially inwardly. This facilitates the reduction in the outer diameter of the tubular portion 12B. Since the protrusion 36B of the head portion 36A of the connection bar 36 urges the tubular portion 12B of the collet 12 radially inwardly, the outer diameter of the tubular portion 12B of the collet 12 can be smaller than that in the ordinary state. The workpiece 16 is held at the outer circumference thereof by a jig (not shown) or the like and is moved in the direction of the rotation axis X to be remove from the collet 12.

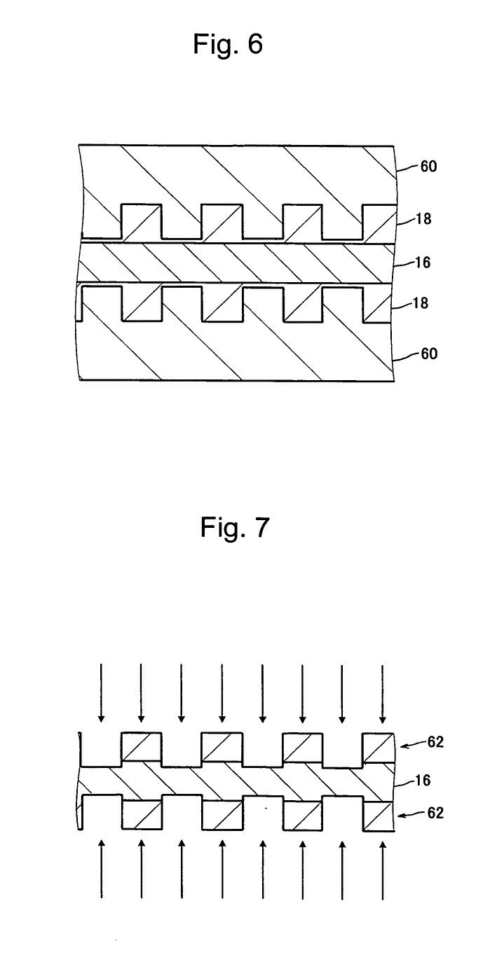

Subsequently, as shown in FIG. 6, a predetermined concavo-convex pattern is transferred to the flowable material 18 using an imprinting method (S104). Specifically, stampers 60 are brought into contact with the flowable material 18 on respective sides of the workpiece 16 to transfer the concavo-convex pattern to the flowable material 18. The above concavo-convex pattern is a concavo-convex pattern corresponding to concave portions and convex portions in the recording layer of, for example, a discrete track medium or a patterned medium. Any of optical imprinting using UV light or the like, thermal imprinting, and the like can be used as the imprinting method.

When optical imprinting is used, a radiation curable resin such as a UV curable resin is used as the flowable material 18. In this case, the stampers 60 used are light-transmittable, and the flowable material 18 is irradiated with radiation such as UV light through the stampers 60 to cure the flowable material 18 while the shapes of the transferred concavo-convex patters are maintained.

Meanwhile, when thermal imprinting is used, a thermosetting resin or the like is used as the flowable material 18. In this case, the flowable material 18 is cooled together with the stampers 60 to cure the flowable material 18 while the shapes of the transferred concavo-convex patters are maintained.

Subsequently, as shown in FIG. 7, the workpiece 16 is etched in accordance with resin layers 62 formed of the cured flowable material 18 shaped into the concavo-convex patterns (S106). Concavo-convex patterns corresponding to the concavo-convex patterns of the resin layers 62 are thereby formed on both sides of the workpiece 16. Dry etching such as IBE or RIE can be used as the etching method. The arrows in FIG. 7 schematically represent the irradiation direction of processing gas used in dry etching. For example, when the workpiece 16 has a structure in which processing target layers such as recording layers are formed on both sides of the substrate and the processing target layers appear on the surface of the workpiece 16, the processing target layers are directly etched in accordance with the patterned resin layers 62. Alternatively, for example, when the workpiece 16 has a structure in which processing target layers such as recording layers are formed on both sides of the substrate and one or a plurality of mask layers are formed on each processing target layer, the mask layers are etched in accordance with the patterned resin layer 62, and then the processing target layers are etched in accordance with the patterned mask layers. In the manner described above, discrete track media or patterned media having concavo-convex recording layers on both sides are obtained. If necessary, the step of filling concave portions in the concavo-convex pattern by depositing a non-magnetic material or the like and the step of flattening the surface by removing the excess non-magnetic material by etching may be performed after the above etching step (S106). The step of depositing a protection layer and a lubrication layer may also be performed.

Subsequently, the step of applying the flowable material to both sides of the workpiece 16 (S102), the step of transferring the concavo-convex pattern to the flowable material 18 (S104), and the step of etching the workpiece 16 (S106) are repeated in the manner described above.

As described above, the spin coating apparatus 10 can apply the flowable material 18 to both sides of the workpiece 16 while the workpiece 16 is held at the center hole 16A by the collet 12 with both sides of the workpiece 16 exposed. Therefore, high production efficiency is obtained.

Moreover, the main portion 14A of the diameter-expanding member 14 is urged in the direction of the rotation axis X and comes in contact with the tapered surface 12D of the collet 12 from the top portion 12A side, and the tubular portion 12B of the collet 12 is thereby urged radially outwardly. Therefore, the neck portion 12G of the top portion 12A of the collet 12 is fitted into the inner circumference of the center hole 16A of the workpiece 16, and the radial movement of the workpiece 16 can be reliably restricted. Further, since the neck portion 12G of the top portion 12A of the collet 12 is fitted into the inner circumference of the center hole 16A of the workpiece 16, the movement of the workpiece 16 in the direction of the rotation axis X can also be reliably restricted. Therefore, the workpiece 16 rotated at a high speed can be securely held.

Furthermore, in the spin coating apparatus 10, the connection bar 36 serves as a diameter-reducing member that can urge the tubular portion 12B of the collet 12 radially inwardly. Therefore, the outer diameter of the tubular portion 12B can be reduced rapidly and reliably. In addition, the outer diameter of the tubular portion 12B of the collet 12 can be smaller than that in the state in which the large-diameter portion of the main portion 14A of the diameter-expanding member 14 is moved in the direction away from the tapered surface 12D of the collet 12 to reduce the outer diameter of the tubular portion 12B only by the elastic force of the collet 12. Accordingly, the workpiece 16 can be easily attached to and removed from the collet 12.

Meanwhile, the use of the collet 12 having the slits 12C formed therein can cause unevenness in thickness, like wind ripple patterns, in the flowable material 18 applied to the workpiece 16. More specifically, substantially arc-shaped wind ripple patterns extending radially outwardly from the slits 12C of the collet 12 can be formed on the flowable material 18. Such wind ripple patterns are more likely to be formed particularly on the rear surface of the workpiece 16 (the surface opposite to the surface of the workpiece 16 facing in the same direction as the end face of the top portion 12A of the tubular portion 12B of the collet 12 facing the direction of the rotation axis X) and are less likely to be formed on the front surface of the workpiece 16 (the surface facing in the same direction as the end face of the top portion 12A of the tubular portion 12B of the collet 12 facing the direction of the rotation axis X).

On the other hand, in the spin coating apparatus 10, the diameter-expanding member 14 serves also as a covering member that can cover the hole inside the tubular portion 12B at the top portion 12A of the collet 12 and can also cover at least parts of the slits 12C at the end face of the top portion 12A facing the direction of the rotation axis X. Therefore, the flow of air from the front side to the rear side of the workpiece 16 is suppressed. This can suppress the formation of the wind ripple patterns described above. The effect of suppressing the formation of the wind ripple patterns will also be described later in Working Examples.

Moreover, since the spin coating apparatus 10 is configured such that the workpiece 16 is held by the top portion 12A of the collet 12, the length of a part of the slits 12C between the workpiece 16 and the end face of the collet 12 facing the direction of the rotation axis X is short. Further, the end face of the top portion 12A of the collet 12 is covered with the diameter-expanding member 14 serving also as the covering member. Therefore, the flow of air into the slits 12C on the front side of the workpiece 16 and the flow of air from the front side to the rear side of the workpiece 16 through the slits 12C are suppressed, and this enhances the effect of suppressing the formation of wind ripple patterns.

Moreover, since the diameter-expanding member 14 serves also as the covering member, the structure of the spin coating apparatus 10 is simplified. In addition, the connection bar 36 to which the diameter-expanding member 14 is connected serves also as the diameter-reducing member that can reduce the outer diameter of the tubular portion 12B by urging the tubular portion 12B of the collet 12 radially inwardly. Therefore, the structure of the spin coating apparatus 10 is simplified also in this respect.

In the above exemplary embodiment, the diameter-expanding member 14 serves also as the covering member. However, a covering member that can cover the hole inside the tubular portion at the top portion of the collet and can also cover at least parts of the slits at the end face of the top portion facing the direction of the rotation axis may be provided separately from the diameter-expanding member.

In the above exemplary embodiment, the spin coating apparatus 10 includes the covering member (the diameter-expanding member 14). However, for example, when wind ripple patterns are less likely to be formed, or when wind ripple patterns are formed only near the center hole of the workpiece and are not formed in an area corresponding to the recording area of a magnetic recording medium, the spin coating apparatus 10 may not include the covering member that can cover the hole inside the tubular portion at the top portion of the collet and can also cover at least parts of the slits at the end face of the end facing the direction of the rotation axis.

In the above exemplary embodiment, the diameter-expanding member 14 is urged in the direction of the rotation axis, and the main portion 14A comes in contact with the tapered surface 12D of the collet 12 from the top portion 12A side. The tubular portion 12B of the collet 12 is thereby urged radially outwardly to expand the outer diameter of the tubular portion 12B. However, no particular limitation is imposed on the structures of the collet and the diameter-expanding member, so long as the outer diameter of the tubular portion 12B can be expanded. For example, only one of the outer circumferential surface of the main portion 14A and the inner circumferential surface of the collet 12 may be a tapered surface. The other surface may not be a tapered surface and may be, for example, a cylindrical surface. Moreover, the collet and the diameter-expanding member may be configured, for example, such that the tubular portion of the collet is urged radially outwardly to expand the outer diameter of the tubular portion by bringing a tapered surface of the diameter-expanding member into contact with a tapered surface of the collet from the side opposite to the top portion. Furthermore, for example, a bag-like diameter-expanding member made of silicon rubber or the like may be disposed inside the tubular portion of the collet. In this case, compressed air is supplied to the diameter-expanding member to expand the outer diameter of the tubular portion.

In the spin coating apparatus 10 in the above exemplary embodiment, the connection bar 36 to which the diameter-expanding member 14 is connected serves as the diameter-reducing member that can urge the tubular portion 12B of the collet 12 radially inwardly. However, no particular limitation is imposed on the structure of the diameter-reducing member. For example, a diameter-reducing member separate from the connection bar may be used. Meanwhile, for example, when the outer diameter of the tubular portion can be rapidly and reliably reduced and/or when the workpiece 16 can be easily attached to and removed from the collet 12 without urging the tubular portion radially inwardly by the diameter-reducing member, the diameter-reducing member may be omitted.

In the above exemplary embodiment, the neck portion 12G is formed in the top portion 12A of the collet 12 that is fitted into the inner circumference of the center hole 16A of the workpiece 16. However, no particular limitation is imposed on the shape of the top portion of the collet, so long as the workpiece rotated at a high speed can be securely held. For example, the shape of the top portion of the collet that is fitted into the inner circumference of the center hole of the workpiece may be a stepped shape that restricts the movement of the workpiece in one direction along the rotation axis and does not restrict the movement of the workpiece in the other direction.

In the above exemplary embodiment, the collet 12 is configured to hold the workpiece 16 at the top portion 12A. However, the workpiece may be held at any portion other than the top portion in the tubular portion of the collet, so long as the flowable material can be preferably applied to both sides of the workpiece.

In the above exemplary embodiment, discrete track media or patterned media are exemplified. However, the spin coating apparatus 10 can be used to manufacture other information recording media. In addition, the spin coating apparatus 10 can be used to manufacture products other than information recording media.

### Working Example 1

In contrast to the above exemplary embodiment, a spin coating apparatus was prepared in which the flange portion 14B of the diameter-expanding member 14 was omitted and the slits 12C were not covered at the end face of the top portion 12A of the collet 12 facing the direction of the rotation axis X. The flowable material 18 was applied to both sides of the workpiece 16 by the method described in the above exemplary embodiment. The flowable material 18 was a UV curable resin. The workpiece 16 was prepared by depositing recoding layers and other layers on both sides of the substrate for a hard disk. The rotation speed of the workpiece 16 in the flowable material applying step (S102) was 10,000 rpm. The dimensions of the workpiece 16 were as follows.

Outer diameter: 48 mm

Diameter of the center hole 16A: 12 mm

Diameter of the inner circumference of the recording area: 20 mm

Thickness: 0.5 mm

Observation was made on the flowable material 18 applied to both sides of the workpiece 16. The thickness of the flowable material 18 applied to areas corresponding to the recording areas of the workpiece 16 was approximately 35 nm for both the front surface (the surface facing in the same direction as the end face of the top portion 12A of the tubular portion 12B of the collet 12 facing the direction of the rotation axis X) and the rear surface (the surface opposite to the surface of the workpiece 16 facing in the same direction as the end face of the top portion 12A of the tubular portion 12B of the collet 12 facing the direction of the rotation axis X). The thickness was substantially uniform in the area corresponding to the recording area.

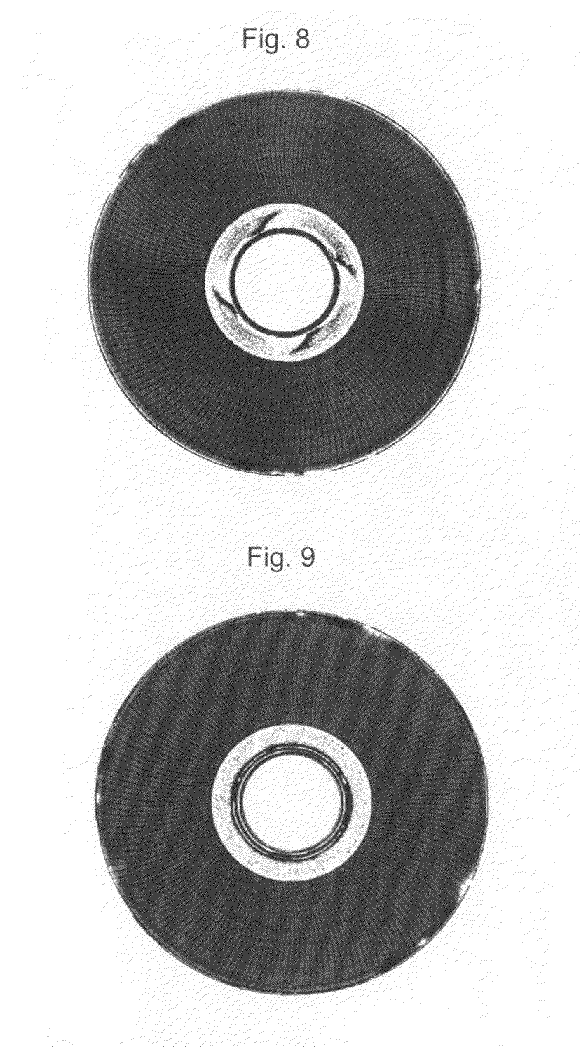

However, as shown in FIG. 8, substantially arc-shaped wind ripple patterns extending radially outwardly from the slits 12C of the collet 12 were found to be formed near the center hole 16A on the rear surface of the workpiece 16. Wind ripple patterns were also found to be formed on the front surface of the workpiece 16. However, the wind ripple patterns on the front surface (not shown) were significantly smaller than those on the rear surface. Note that both the wind ripple patterns on the front surface and on the rear surface were formed in areas radially inside the areas corresponding to the recording areas, and no wind ripple patterns were formed in the areas corresponding to the recording areas.

### Working Example 2

A spin coating apparatus having the same structure as that described in the above exemplary embodiment was prepared. That is, a spin coating apparatus 10 was prepared in which the slits 12C were covered at the end face of the top portion 12A of the collet 12 facing the direction of the rotation axis X. The rest of the conditions were the same as those in Working Example 1, and the flowable material 18 was applied to both sides of the workpiece 16.

Observation was made on the flowable material 18 applied to both sides of the workpiece 16. The thickness of the flowable material 18 applied to areas corresponding to the recording areas of the workpiece 16 was approximately 35 nm for both the front surface and the rear surface, as in Working Example 1, and the thickness was substantially uniform in the areas corresponding to the recording areas.

Meanwhile, as shown in FIG. 9, wind ripple patterns like those observed in Working Example 1 were not formed on the rear surface of the workpiece 16 in Working Example 2. Moreover, wind ripple patterns were not formed on the front surface of the workpiece 16 either (not shown).

As described in Working Examples 1 and 2, it was found that the flowable material 18 can be favorably applied to both sides of the workpiece 16 by holding the workpiece 16 at the center hole 16A by the collet 12 such that both sides of the workpiece 16 are exposed.

Further, as described in Working Example 2, it was found that the formation of wind ripple patterns like those observed in Working Example 1 can be suppressed by covering the hole inside the tubular portion 12B at the top portion 12A of the collet 12 and also covering the slits 12C at the end face of the top portion 12A facing the direction of the rotation axis X.

Various exemplary embodiments of the present invention can be utilized to apply a flowable material to both sides of a workpiece in a process, for example, for manufacturing an information recording medium.

What is claimed is:

1. A spin coating apparatus, comprising:
a collet including a tubular portion disposed coaxially with a predetermined rotation axis, the tubular portion having a slit that extends from a top portion of the tubular portion in a direction of the rotation axis to a midway part in the direction of the rotation axis; and
a diameter-expanding member for urging the tubular portion of the collet radially outwardly to expand an outer diameter of the tubular portion, wherein
while a plate-like workpiece having a center hole is held at the center hole by the tubular portion of the collet with both sides of the workpiece exposed, the spin coating apparatus can apply a flowable material to both the sides of the workpiece.

2. The spin coating apparatus according to claim 1, further comprising a covering member for covering a hole inside the tubular potion at the top portion of the collet and also covering at least part of the slit at an end face of the top portion facing the direction of the rotation axis.

3. The spin coating apparatus according to claim 2, wherein the diameter-expanding member serves also as the covering member.

4. The spin coating apparatus according to claim 1, further comprising a pair of nozzle portions for applying the flowable material to both the sides of the workpiece.

5. The spin coating apparatus according to claim 2, further comprising a pair of nozzle portions for applying the flowable material to both the sides of the workpiece.

6. The spin coating apparatus according to claim 1, further comprising a diameter-reducing member for urging the tubular portion of the collet radially inwardly.

7. The spin coating apparatus according to claim 2, further comprising a diameter-reducing member for urging the tubular portion of the collet radially inwardly.

8. The spin coating apparatus according to claim 4, further comprising a diameter-reducing member for urging the tubular portion of the collet radially inwardly.

9. The spin coating apparatus according to claim 1, wherein the collet further includes a neck portion formed at the top portion of the tubular portion, the neck portion having an outer diameter smaller than an outer diameter of adjoining portions on both sides thereof in the direction of the rotation axis, the collet being configured so as to hold the workpiece with the neck portion fitted into the center hole of the workpiece.

10. The spin coating apparatus according to claim 2, wherein the collet further includes a neck portion formed at the top portion of the tubular portion, the neck portion having an outer diameter smaller than an outer diameter of adjoining portions on both sides thereof in the direction of the rotation axis, the collet being configured so as to hold the workpiece with the neck portion fitted into the center hole of the workpiece.

11. The spin coating apparatus according to claim 4, wherein the collet further includes a neck portion formed at the top portion of the tubular portion, the neck portion having an outer diameter smaller than an outer diameter of adjoining portions on both sides thereof in the direction of the rotation axis, the collet being configured so as to hold the workpiece with the neck portion fitted into the center hole of the workpiece.

12. The spin coating apparatus according to claim 6, wherein the collet further includes a neck portion formed at the top portion of the tubular portion, the neck portion having an outer diameter smaller than an outer diameter of adjoining portions on both sides thereof in the direction of the rotation axis, the collet being configured so as to hold the workpiece with the neck portion fitted into the center hole of the workpiece.

13. A spin coating method, comprising applying the flowable material to both the sides of the workpiece using the spin coating apparatus according to claim 1.

14. A spin coating method, comprising applying the flowable material to both the sides of the workpiece using the spin coating apparatus according to claim 2.

15. A spin coating method, comprising applying the flowable material to both the sides of the workpiece using the spin coating apparatus according to claim 4.

16. A spin coating method, comprising applying the flowable material to both the sides of the workpiece using the spin coating apparatus according to claim 6.

17. A method for manufacturing an information recording medium, comprising a step of applying the flowable material to both the sides of the workpiece using the spin coating apparatus according to claim 1.

18. A method for manufacturing an information recording medium, comprising a step of applying the flowable material to both the sides of the workpiece using the spin coating apparatus according to claim 2.

19. A method for manufacturing an information recording medium, comprising a step of applying the flowable material to both the sides of the workpiece using the spin coating apparatus according to claim 4.

20. A method for manufacturing an information recording medium, comprising a step of applying the flowable material to both the sides of the workpiece using the spin coating apparatus according to claim 6.
